(19) United States
(12) Patent Application Publication
(10) Pub. No.: US 2022/0058298 A1
(43) Pub. Date: Feb. 24, 2022

(54) Computer Aided Design System For Designing Multilevel Lattice Structures

(71) Applicants: Siemens Industry Software Inc., Plano, TX (US); Georgia Tech Research Corporation, Atlanta, GA (US)

(72) Inventors: Ashish Gupta, Marietta, GA (US); Kelsey Kurzeja, Atlanta, GA (US); Jaroslaw Rossignac, Atlanta, GA (US); Suraj Ravi Musuvathy, Princeton Junction, NJ (US); George Allen, Okinawa (JP); Mark R. Burhop, Ewing, NJ (US); Livio Dalloro, Plainsboro, NJ (US)

(21) Appl. No.: 17/274,461

(22) PCT Filed: Sep. 5, 2019
(86) PCT No.: PCT/US2019/049635

§ 371 Date: Mar. 9, 2021

Related U.S. Application Data
(60) Provisional application No. 62/730,723, filed on Sep. 13, 2018.

(51) Int. Cl. G06F 30/10

(52) U.S. Cl. CPC G06F 30/10; G06F 2113/10

(57) ABSTRACT

Methods and systems are disclosed for a computer aided design system for designing multilevel lattice structures. A coarse lattice module defines a coarse lattice of balls connected by beams within a first boundary. A fine lattice module defines a fine lattice of balls connected by beams within a second boundary. The coarse lattice and the fine lattice have intersecting regions. A trimming module constructs a multilevel lattice structure according to a trimming operation based on the intersecting regions.

### STATEMENT REGARDING FEDERALLY SPONSORED RESEARCH OR DEVELOPMENT

This invention was made with government support under the Government Prime Award No: HR0011-17-2-0015 awarded by the United States Defense Advanced Research Projects Agency (DARPA). The government has certain rights in the invention.

### TECHNICAL FIELD

This application relates to computer aided design (CAD). More particularly, this application relates to a CAD modeling of multilevel lattice structures.

### BACKGROUND

Additive manufacturing enables manufacturing of parts with unprecedented physical properties. This is achieved primarily by designing an internal microstructure, which is often described as a truss like lattice of balls and connecting beams. One of the ways to design this microstructure is to define it as a multilevel lattice in which each element (ball or beam), at a coarse level, is a lattice (i.e., a lattice of a lattice, such as the Eiffel Tower). While the effect of hierarchy on material properties is being investigated, one of the big challenges is to represent and model multilevel lattice structures in a compact and efficient manner. Traditional boundary representations of such lattices are far too large to be manageable.

Most CAD systems that have lattice modeling features today provide the ability to model single level lattices. In addition, the kinds of lattices are limited to patterns of a template of balls and beams. Modeling multilevel lattices with standard CAD functionality would be very tedious and time consuming, and the resulting models would be enormous, straining the limits of graphical processing and display on the CAD system.

### SUMMARY

Methods and systems are disclosed for CAD modeling of multilevel lattice structures. Various combinations are disclosed for defining coarse and fine lattice structures, from which new next-level lattice structures can be constructed by recursive trimming operations or by flood filling.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 shows an example of a set of application modules for a CAD system to design multilevel lattices according to embodiments of this disclosure;

FIG. 2 shows an example of a recursive trimming operation to construct multilevel lattices according to embodiments of this disclosure;

FIG. 3 shows an example of a trimming operation using a periodic template to construct a multilevel lattice according to embodiments of this disclosure

FIG. 4 shows an example of a trimming operation that trims a fine lattice by a coarse lattice according to embodiments of this disclosure;

FIG. 5 shows an example of a multilevel lattice constructed by defining a fine lattice from subdivisions of a coarse lattice according to embodiments of this disclosure;

FIG. 6 shows an example of a multilevel lattice constructed by defining a fine lattice by flood filling inside a coarse lattice according to embodiments of this disclosure; and

FIG. 7 shows an example of a computing environment within which embodiments of this disclosure may be implemented.

### DETAILED DESCRIPTION

Methods and systems are disclosed for CAD modeling of multilevel lattice structures for optimizing computer processing by minimizing fine lattice generation. Herein, a “fine” lattice is defined as a lattice structure in which beams can be as thin as 3D printer can generate (e.g., 1 mil), and beam lengths are as small as 0.25-1.0 cm. A “coarse” lattice is generally defined as a lattice structure in which structure elements are significantly greater in scale than for the fine lattice. For example, a coarse lattice may comprise beams with a thickness several multiples of fine lattice beams or fine lattice kernels. In some embodiments, the coarse lattice construction allows a CAD designer to “rough out” a lattice structure before introducing a fine lattice generation for the purpose of minimizing the heavy computational processing that may overburden the computer system. For example, rendering a large scale lattice, such as having an actual scale of several meters to a hundred meters, with primarily fine lattice structures may cause a time delay of several minutes or possibly crash a CAD program. The methods and systems described below provide a technical solution for modeling multilevel lattices by recursively alternating between fine and coarse lattice representations within a boundary of lattice structure with trimming operations that remove patterns of lattice structure.

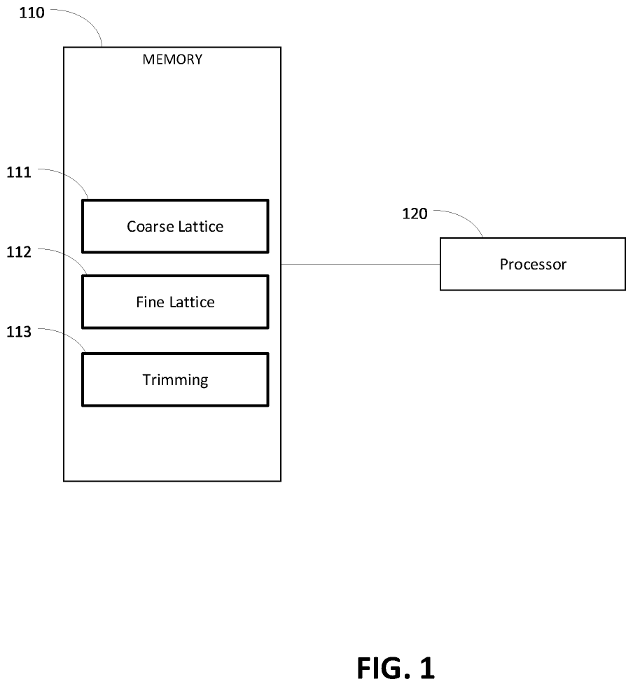

FIG. 1 shows an example of a set of application modules for a CAD system to design multilevel lattices according to embodiments of this disclosure. A CAD system includes a processor 120 and memory 110 having stored various programs used to design multilevel lattices. A coarse lattice module 111 includes algorithms for defining a coarse lattice of the multilevel lattice. A fine lattice for the multilevel lattice is defined by fine lattice module 112. A trimming module 113 includes algorithms used for performing trimming operations that remove portions of fine lattice or coarse lattice from the multilevel lattice structure during design of the multilevel lattice as will be described in further detail below.

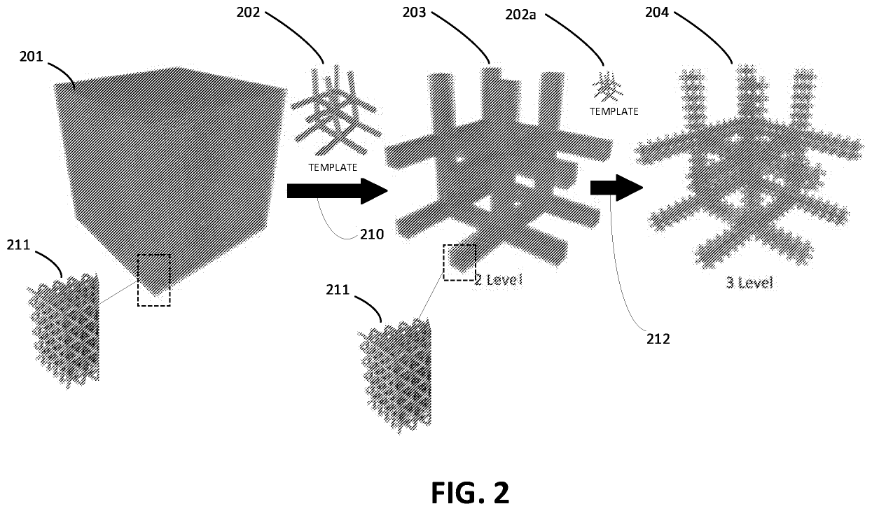

FIG. 2 shows an example of a recursive trimming operation to construct multilevel lattices according to embodiments of this disclosure. In an embodiment, the fine lattice module 111 defines a fine lattice structure 201 with a boundary and by a fine lattice of kernels of a particular geometry as shown in detail 211. Using coarse lattice module 112, a coarse lattice is defined with a topology according to a template 202 to fit within the boundary of the fine lattice structure 201. A two-level multilevel lattice structure 203 is constructed by trimming module 113 performing a trimming operation 210. In an embodiment, a Boolean field may be defined by the coarse lattice module 112 with a topology that extends the coarse lattice by a distance r outward from the lateral elements of the template. A logical function may be defined for the Boolean field based on the coarse lattice that gives a 0 value for fine lattice not intersecting with the coarse lattice, and a 1 value for fine lattice that does intersect with the coarse lattice. In this example, the fine lattice is trimmed away for value 0, and kept for value 1. The Boolean function may be defined as a parametric function or an implicit function. In a recursive manner, a second trimming operation 212 may be performed by the trimming module 113, whereby multiple coarse lattices are defined along the fine lattice structure 203 according to rescaled template 202a. Again using the trimming module 113, fine lattice is trimmed away for regions that do not have an intersection between the fine lattice and the coarse lattice, to produce a three-level lattice structure 204. To resolve trimming balls of the fine lattice, the intersection may be defined based on a center point of the ball. Trimming beams of fine lattice may be defined by intersection of one or two balls connected by a beam falling within the coarse lattice. Additional recursive operations of the fine level module 111, coarse level module 112 and trimming module 113 may be repeated for further modifications to the multilevel lattice 204 to construct multilevel lattices at a four-level and beyond. At any one of the recursive operations, the fine lattice module 111 may redefine the kernel geometry for some portions or all of the remaining fine lattice. The technical advantage of the embodiments related to FIG. 2 includes improved efficiency of constructing each element of the multilevel lattice, such as application of a template for clustering of trimming operations. This conserves computing resources compared with constructing a fine lattice along complex multilevel topologies one element at a time.

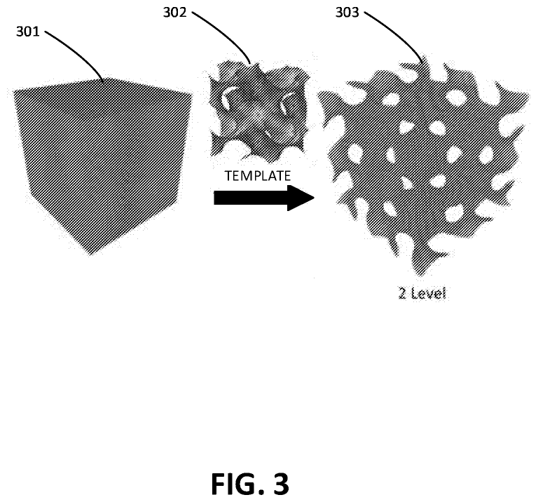

FIG. 3 shows an example of a trimming operation using a periodic template to construct a multilevel lattice according to embodiments of this disclosure. Fine lattice module 111 may define a fine lattice 301 having a boundary as shown in FIG. 3. A periodic structure, such as a gyroid, may be selected as template 302. The coarse lattice module 112 may define a Boolean field based on the template 302 in a similar manner as described above with respect to FIG. 2, against which the trimming module 113 performs a trimming operation to remove fine lattice that does not intersect with the coarse lattice. The resulting two-level lattice 303 has a topology based on the template structure 302.

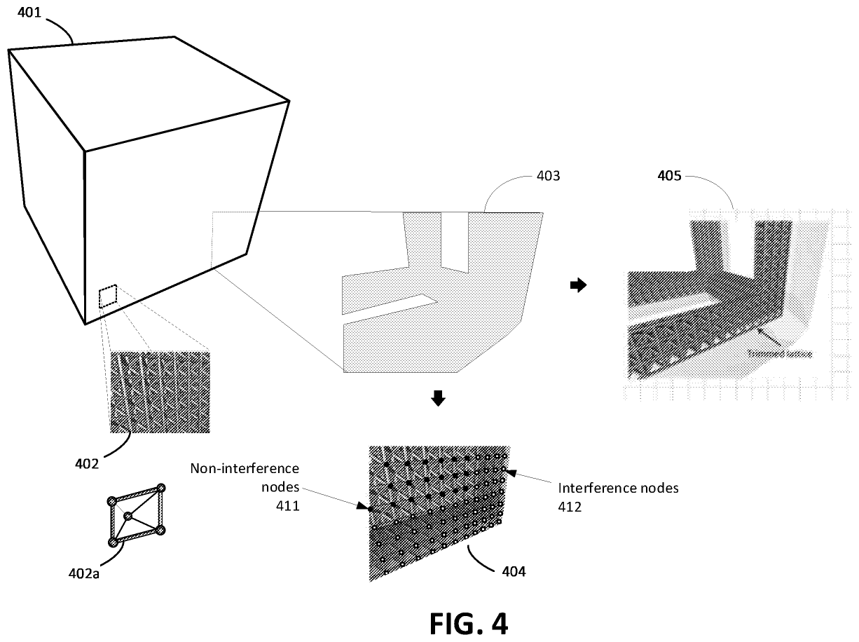

FIG. 4 shows an example of a trimming operation that trims a fine lattice by a coarse lattice according to embodiments of this disclosure. In an embodiment, a fine lattice 401 and a coarse lattice 403 may defined independently by fine lattice module 111 and coarse lattice module 112. In this example, the fine lattice may have a geometry 402 based on a kernel 402a. For simplicity of illustration, only a portion of coarse lattice 403 is shown. Trimming module 113 performs a trimming operation 404 by identifying non-interference nodes 411 and interference nodes 412, removing fine lattice that consists of the non-interference node 411, and constructing the multilevel lattice 405 showing trimmed fine lattice that remains.

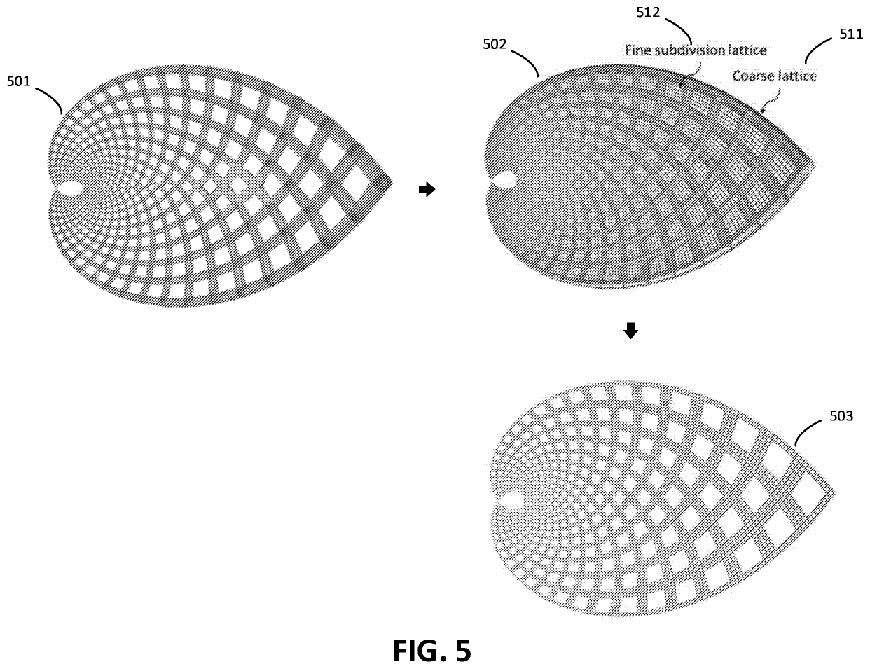

FIG. 5 shows an example of a multilevel lattice modeled by defining a fine lattice from subdivisions of a coarse lattice according to embodiments of this disclosure. In an embodiment, a coarse lattice 501 is defined by coarse lattice module 112. The fine lattice module 111 performs a subdivision operation 502 that defines fine lattice 512 as a subdivision of coarse lattice 511. For example, all beams of coarse lattice 511 may be subdivided into sixths and tessellated across the coarse lattice in a woven pattern as shown in FIG. 5. The trimming module 113 performs a trimming operation to produce a two-level lattice 503 by removing fine lattice structure 512 that does not intersect with coarse lattice structure 511.

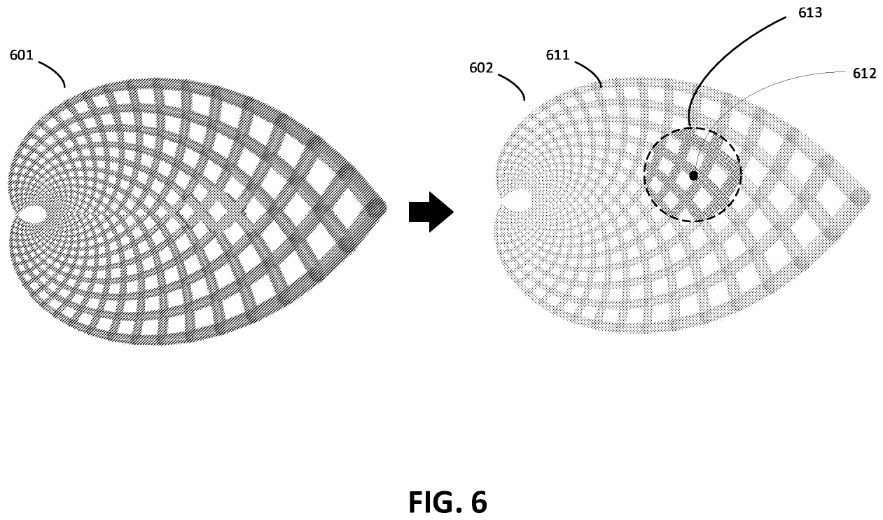

FIG. 6 shows an example of a multilevel lattice modeled by defining a fine lattice by flood filling inside a coarse lattice according to embodiments of this disclosure. In an embodiment, as a variant of the modeling described above for FIG. 5, the trimming operation is replaced by a flood filling of fine lattice within the coarse lattice. A coarse lattice 601 is defined by coarse lattice module 112, and a flood filling operation 602 is performed by fine lattice module 111 based on a single point 612 and a radial distance to define a boundary 613 for the fine lattice. The resulting multilevel lattice may be recursively flood filled to add additional fine lattice structure within the coarse lattice 611. The geometry of the fine lattice may be defined independently of the coarse lattice 601, or may be a subdivision operation as described above for subdivision 502 in FIG. 5.

The aforementioned systems and methods enable CAD-based representation of large scale multilevel lattices with more than trillions of elements. A variety of multilevel lattices may be represented, ranging from a simple grid like structure to helical and Gyroid shaped structures. Fast, on-demand generation of lattice portions avoid iterating over an entire lattice structure.

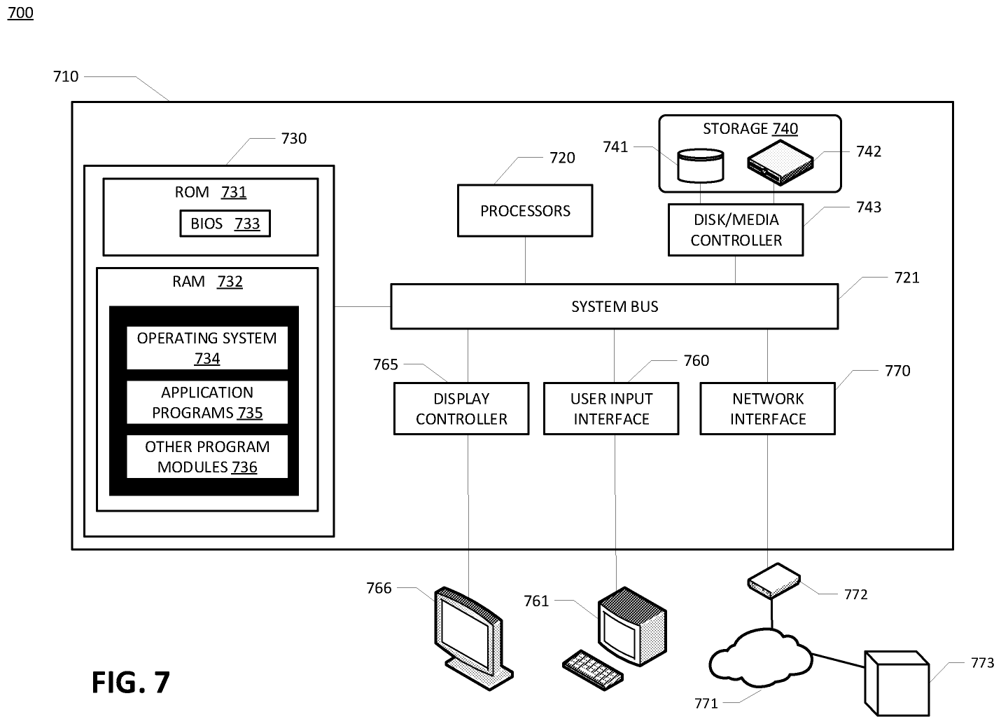

FIG. 7 illustrates an example of a computing environment within which embodiments of the present disclosure may be implemented. A computing environment 700 includes a computer system 710 that may include a communication mechanism such as a system bus 721 or other communication mechanism for communicating information within the computer system 710. The computer system 710 further includes one or more processors 720 coupled with the system bus 721 for processing the information. In an embodiment, computing environment 700 corresponds to a portion of a CAD system, in which the computer system 710 relates to a central unit 301 described below in greater detail.

The processors 720 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 720 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 721 may include at least one of a system bus, a memory bus, an address bus, or a message bus, and may permit exchange of information (e.g., data (including computer-executable code), signaling, etc.) between various components of the computer system 710. The system bus 721 may include, without limitation, a memory bus or a memory controller, a peripheral bus, an accelerated graphics port, and so forth. The system bus 721 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 7, the computer system 710 may also include a system memory 730 coupled to the system bus 721 for storing information and instructions to be executed by processors 720. The system memory 730 may include computer readable storage media in the form of volatile and/or nonvolatile memory, such as read only memory (ROM) 731 and/or random access memory (RAM) 732. The RAM 732 may include other dynamic storage device(s) (e.g., dynamic RAM, static RAM, and synchronous DRAM). The ROM 731 may include other static storage device(s) (e.g., programmable ROM, erasable PROM, and electrically erasable PROM). In addition, the system memory 730 may be used for storing temporary variables or other intermediate information during the execution of instructions by the processors 720. A basic input/output system 733 (BIOS) containing the basic routines that help to transfer information between elements within computer system 710, such as during start-up, may be stored in the ROM 731. RAM 732 may contain data and/or program modules that are immediately accessible to and/or presently being operated on by the processors 720. System memory 730 may additionally include, for example, operating system 734, application modules 735, and other program modules 736. Application modules 735 may include aforementioned application modules and may also include a user portal for development or modification of the application programs.

The operating system 734 may be loaded into the memory 730 and may provide an interface between other application software executing on the computer system 710 and hardware resources of the computer system 710. More specifically, the operating system 734 may include a set of computer-executable instructions for managing hardware resources of the computer system 710 and for providing common services to other application programs (e.g., managing memory allocation among various application programs). In certain example embodiments, the operating system 734 may control execution of one or more of the program modules depicted as being stored in the data storage 740. The operating system 734 may include any operating system now known or which may be developed in the future including, but not limited to, any server operating system, any mainframe operating system, or any other proprietary or non-proprietary operating system.

The computer system 710 may also include a disk/media controller 743 coupled to the system bus 721 to control one or more storage devices for storing information and instructions, such as a magnetic hard disk 741 and/or a removable media drive 742 (e.g., floppy disk drive, compact disc drive, tape drive, flash drive, and/or solid state drive). Storage devices 740 may be added to the computer system 710 using an appropriate device interface (e.g., a small computer system interface (SCSI), integrated device electronics (IDE), Universal Serial Bus (USB), or FireWire). Storage devices 741, 742 may be external to the computer system 710.

The computer system 710 may also include a display controller 765 coupled to the system bus 721 to control a display or monitor 766, such as a cathode ray tube (CRT) or liquid crystal display (LCD), for displaying information to a computer user. The computer system 710 may include a user input interface or graphical user interface (GUI) 761, which may comprise one or more input devices, such as a keyboard, touchscreen, tablet and/or a pointing device, for interacting with a computer user and providing information to the processors 720. The display 766 may provide a touch screen interface which allows input to supplement or replace the communication of direction information and command selections by the user terminal device 761.

The computer system 710 may perform a portion or all of the processing steps of embodiments of the invention in response to the processors 720 executing one or more sequences of one or more instructions contained in a memory, such as the system memory 730. Such instructions may be read into the system memory 730 from another computer readable medium of storage 740, such as the magnetic hard disk 741 or the removable media drive 742. The magnetic hard disk 741 and/or removable media drive 742 may contain one or more data stores and data files used by embodiments of the present disclosure. The data store 740 may include, but are not limited to, databases (e.g., relational, object-oriented, etc.), file systems, flat files, distributed data stores in which data is stored on more than one node of a computer network, peer-to-peer network data stores, or the like. Data store contents and data files may be encrypted to improve security. The processors 720 may also be employed in a multi-processing arrangement to execute the one or more sequences of instructions contained in system memory 730. In alternative embodiments, hard-wired circuitry may be used in place of or in combination with software instructions. Thus, embodiments are not limited to any specific combination of hardware circuitry and software.

As stated above, the computer system 710 may include at least one computer readable medium or memory for holding instructions programmed according to embodiments of the invention and for containing data structures, tables, records, or other data described herein. The term “computer readable medium” as used herein refers to any medium that participates in providing instructions to the processors 720 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 741 or removable media drive 742. Non-limiting examples of volatile media include dynamic memory, such as system memory 730. Non-limiting examples of transmission media include coaxial cables, copper wire, and fiber optics, including the wires that make up the system bus 721. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. Each block of the flowchart illustrations and/or block diagrams, and combinations of blocks in the flowchart illustrations and/or block diagrams, may be implemented by computer readable medium instructions.

The computing environment 700 may further include the computer system 710 operating in a networked environment using logical connections to one or more remote computers, such as remote computing device 773. The network interface 770 may enable communication, for example, with other remote devices 773 or systems and/or the storage devices 741, 742 via the network 771. Remote computing device 773 may be a personal computer (laptop or desktop), a mobile device, a server, a router, a network PC, a peer device or other common network node, and typically includes many or all of the elements described above relative to computer system 710. When used in a networking environment, computer system 710 may include modem 772 for establishing communications over a network 771, such as the Internet. Modem 772 may be connected to system bus 721 via user network interface 770, or via another appropriate mechanism.

Network 771 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 710 and other computers (e.g., remote computing device 773). The network 771 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 771.

The program modules, applications, computer-executable instructions, code, or the like depicted in FIG. 7 as being stored in the system memory 730 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 710, the remote device 773, and/or hosted on other computing device(s) accessible via one or more of the network(s) 771, may be provided to support functionality provided by the program modules, applications, or computer-executable code depicted in FIG. 7 and/or additional or alternate functionality. Further, functionality may be modularized differently such that processing described as being supported collectively by the collection of program modules depicted in FIG. 7 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 7 may be implemented, at least partially, in hardware and/or firmware across any number of devices.

It should further be appreciated that the computer system 710 may include alternate and/or additional hardware, software, or firmware components beyond those described or depicted without departing from the scope of the disclosure. More particularly, it should be appreciated that software, firmware, or hardware components depicted as forming part of the computer system 710 are merely illustrative and that some components may not be present or additional components may be provided in various embodiments. While various illustrative program modules have been depicted and described as software modules stored in system memory 730, functionality described as being supported by the program modules may be enabled by any combination of hardware, software, and/or firmware. Each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, numerous other modifications to the illustrative implementations and architectures described herein are also within the scope of this disclosure. In addition, any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer aided design system for generation of a multilevel lattice model, comprising:
a processor; and
a memory having a plurality of application modules stored thereon, comprising:
a coarse lattice module configured to:
define a coarse lattice of balls connected by beams within a first boundary;
a fine lattice module configured to:
define a fine lattice of balls connected by beams within a second boundary;
wherein the coarse lattice and the fine lattice have intersecting regions; and
a trimming module configured to:
construct a multilevel lattice structure according to a trimming operation based on the intersecting regions.

2. The system of claim 1, wherein the trimming operation discards fine lattice structure outside of the intersecting regions.

3. The system of claim 1, wherein additional multilevel lattice structures are constructed by a series of recursive operations by the coarse lattice module, the fine lattice module, and the trimming module, the recursive operations comprising:
the coarse lattice module defining a rescaled coarse lattice within the boundary of the multilevel lattice structure;
wherein the rescaled coarse lattice and the fine lattice have intersecting regions;
the trimming module performing a refined trimming operation that removes fine lattice structure outside the intersecting regions.

4. The system of claim 1, wherein the fine lattice and the coarse lattice are defined independently.

5. The system of claim 1, wherein:
the fine lattice is defined by multiple subdivisions of the coarse lattice beams.

6. The system of claim 1, wherein:
the coarse lattice module defines a Boolean field for a region surrounding at least one beam of the coarse lattice in which the intersecting region is expanded by a distance from an axis of at least one coarse lattice beam.

7. The system of claim 1, wherein the coarse lattice module
defines the coarse lattice by a template having a template surface; and
defines a Boolean field for a region surrounding the template in which the intersecting region is expanded by a distance from the template surface.

8. The system of claim 7, wherein the template is a truss-like lattice.

9. The system of claim 7, wherein the template is a periodic structure.

10. The system of claim 7, wherein the Boolean field is defined by a parametric function.

11. The system of 7, wherein the Boolean field is defined by an implicit function.

12. The system of claim 1, wherein the coarse lattice is defined before the fine lattice, and the second boundary is defined inside the coarse lattice by a flood filling with the fine lattice from a single point.

13. The system of claim 12, wherein the second boundary is defined by a shape with a radius from the single point.

14. The system of claim 1, wherein the first boundary and the second boundary are the same.
